(19) United States
(12) Patent Application Publication
(10) Pub. No.: US 2006/0281614 A1
(43) Pub. Date: Dec. 14, 2006

(54) Filter tube making

(75) Inventors: George R. Scott, Midlothian, VA (US); Martin Heidorn, Chesterfield, VA (US); Martin T. Garthaffner, Chesterfield, VA (US)

Correspondence Address: Connolly Bove Lodge & Hutz LLP, 1007 North Orange Street, P.O. Box 2207, Wilmington, DE, 19899, US

(73) Assignee: Philip Morris USA Inc., Richmond, VA (US)

(21) Appl. No.: 11/443,659

(22) Filed: May 31, 2006

Related U.S. Application Data
(60) Provisional application No. 60/689,128, filed on Jun. 9, 2005.

(51) Int. Cl. B31C 13/00

(52) U.S. Cl. 493/39

(57) ABSTRACT

A process of producing a filter tube comprises the steps of cutting a paper segment of given length and width from an endless paper supply. Next, a filter segment of cellulose acetate tow, for example, is centrally positioned on the paper segment. Opposed tube forming rollers engage the ends of the filter segment, and as these rollers rotate, the paper segment is formed into a tube shape. Overlapping portions of the paper segment are secured together, and the tube forming rollers are withdrawn from the tube to thereby complete the forming operation.

### CROSS REFERENCE RELATED TO APPLICATION

The present application claims the benefit of provisional application Ser. No. 60/689,128, filed Jun. 9, 2005, for all useful purposes, and the specification and drawings thereof are included herein by reference.

### BACKGROUND OF THE INVENTION

The present invention relates to filter tube making, and more particularly to a method of forming a tube with a centrally located filter component within the tube.

U.S. Pat. Nos. 3,517,480 and 3,603,058 illustrate and describe machines for the production of composite cigarette filters by directly flowing granular filter material from a storage hopper into a vertically oriented filter tube. Similarly, US Patent Application Publication 2002/0119874A1 describes another machine for producing compound cigarette filters that includes a series of rotating plates with cavities therein into which the granular filter material is deposited. The cavities ultimately are aligned with an open ended filter tube to facilitate deposit of the granular material into the tube.

Preformed filter tubes are utilized with machinery as described above for primarily producing 2-up (dual) cigarette filters. In each instance these filter tubes primarily comprise a hollow cylindrical tube with a central filter component such as cellulose acetate tow. After both ends of the filter tube are filled with granular material and sealed with solid filter segments a 2-up (dual) filter is produced which when combined with tobacco rods at each end thereof ultimately produces two complete cigarettes. When cutting through the middle of the central filter component, each cigarette filter has a defined length. It is important that the length and inside diameter of the preformed filter tube be accurately controlled so that the tubes can then be easily and accurately filled utilizing vertical filling technology and machinery of the type described above.

### SUMMARY OF THE INVENTION

Accordingly, the primary object of the present invention is a process of producing filter tubes in a highly economical manner and where the filter tubes have accurate predetermined dimensions.

Another object of the present invention is a process of producing filter tubes which is relatively simple, but highly effective using high speed production techniques.

In accordance with the present invention, filter paper is feed and ultimately cut to a length slightly longer than the circumference of a filter tube to be produced. The cut paper segment may be placed on a vacuum plate for transfer in a downstream direction. A filter component is placed at a location where opposed tube forming rollers or mandrels move to engage the opposite ends of the filter component. The tube forming rollers with the filter component between them is then caused to rotate and the paper segment being positioned under the tube forming rollers rotates with them. Vacuum from within the rollers adheres the paper segment to the rollers whereby the paper segment is wrapped around the rollers and the central filter component. A glue line previously applied to the trailing edge of the paper segment then overlaps the paper to seal the tube and thereby complete the forming operation. The tube forming rollers then retract thereby leaving the finished tube.

Essentially the process of producing a filter tube in accordance with the present invention comprises the steps of producing a paper segment of given length and width. A filter component is centrally placed on the paper segment, and the central filter component has a length less then the width of the paper segment. Opposed tube forming rollers are positioned against the ends of the central filter component, and the paper segment adheres to the tube forming rollers while simultaneously rotating the rollers to form the paper into a tube shape. Overlapping portions of the paper segment are secured together, and the rollers are then withdrawn from the formed filter tube.

Preferably the step of providing a paper segment of given length and width includes removing a paper segment of given length and width from an endless paper supply, and such removal may comprise a simple transverse cutting operation. The given length of the paper segment is slightly longer then the circumference of the filter tube to thereby provide overlapping portions during tube formation, and these overlapping portions may be secured together by adhesive.

Preferably the step of temporarily adhering the paper segment to the tube forming rollers includes applying vacuum from the rollers onto the paper segment. The vacuum is preferably applied through a plurality of openings in the tube forming rollers.

Preferably the filter component centrally located in the filter tube comprises cellulose acetate tow, combined filter segment or a plug-space-plug combined filter component.

### BRIEF DESCRIPTION OF THE DRAWINGS

Novel features and advantages of the present invention in addition to those noted above will be become apparent to persons of ordinary skill in the art from a reading of the following detailed description in conjunction with the accompanying drawings wherein similar reference characters refer to similar parts and in which:

FIG. 1 is a top plan view of an endless paper supply from which paper segments are cut for producing filter tubes, according to the present invention;

FIG. 2 is a top plan view illustrating the next sequential step where a filter segment is centrally positioned on the cut paper segment and opposed tube forming rollers are about to engage the ends of the filter segment, according to the present invention;

FIG. 3 is a top plan view illustrating the next sequential step where the tube forming rollers have engaged the ends of the filter segment and the rollers are about to revolve to form the cut paper segment into a tube shape, according to the present invention;

FIG. 4 is a top plan view, illustrating the next sequential step where the paper segment has been formed into a tube and the overlapping longitudinal edges of the paper segment have been secured together by adhesive, according to the present invention;

FIG. 5 is a top plan view of the last sequential step in the tube forming process where the rollers are axially removed from the formed tube, according to the present invention; and

FIG. 6 is a top plan view similar to FIG. 2, but illustrating modified tube forming rollers about to engage the ends of the filter segment, according to the present invention;

FIG. 7 is a top plan view similar to FIG. 3, but illustrating the tube forming rollers of FIG. 6; and

FIG. 8 is a longitudinal sectional view illustrating details of the tube forming rollers of FIGS. 6 and 7.

### DETAILED DESCRIPTION OF THE INVENTION

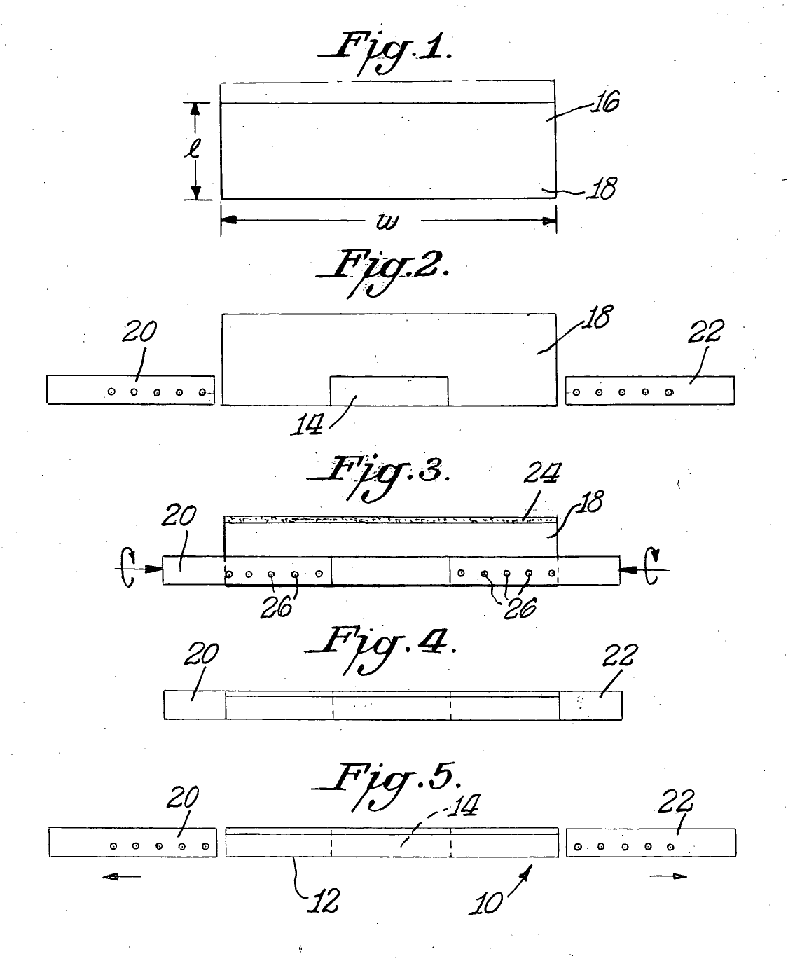

Referring in more particularity to the drawings, FIGS. 1-5 sequentially illustrate a process of producing a finished filter tube 10. Fundamentally, the filter tube comprises a cylindrical portion 12 of filter paper and a central filter 14, preferably cellulose acetate tow. The filter tubes 10 are used to produce 2-up (dual) cigarette filters which are filled with filter materials utilizing vertical filling techniques. Opposite ends of the finished filters are secured to tobacco rods with tipping paper, and cutting the central filter component through the middle thereof produces two cigarettes each with a filter.

FIG. 1 diagrammatically illustrates an endless supply 16 of filter paper from which a paper segment 18 of given length l and width w is removed by cutting, for example. The cut paper segment 18 is then delivered in a downstream direction to a location where the filter segment 14 is centrally placed on the paper segment. As shown in the drawings, the filter segment 14 has a length less then the width of the paper segment so that other filter materials may be deposited into the hollow ends of finished filter tube 10.

Opposed tube forming rollers 20, 22 are aligned with and positioned against the ends of the filter segment 14, as shown best in FIG. 3. The paper segment 18 adheres to the tube forming rollers 20, 22 while the rollers are simultaneously rotated, both in the same direction, to thereby form the paper segment 18 into a tube shape. The length l of the paper segment 18 is slightly longer then the circumference of the finished filter tube 10, and adhesive 24 is applied to the trailing edge of the paper segment. Ultimately the trailing edge overlaps the paper segment and is secured thereto by the adhesive thereby completing formation of the filter tube 10. Rotation of the tube forming rollers 20, 22 is terminated and the rollers are withdrawn from within the formed filter tube.

The step of adhering the paper segment 18 to the tube forming rollers 20, 22 preferably includes the application of vacuum from inside the rollers onto the paper segment. The vacuum is applied through a plurality of openings 26 in each of the tube forming rollers.

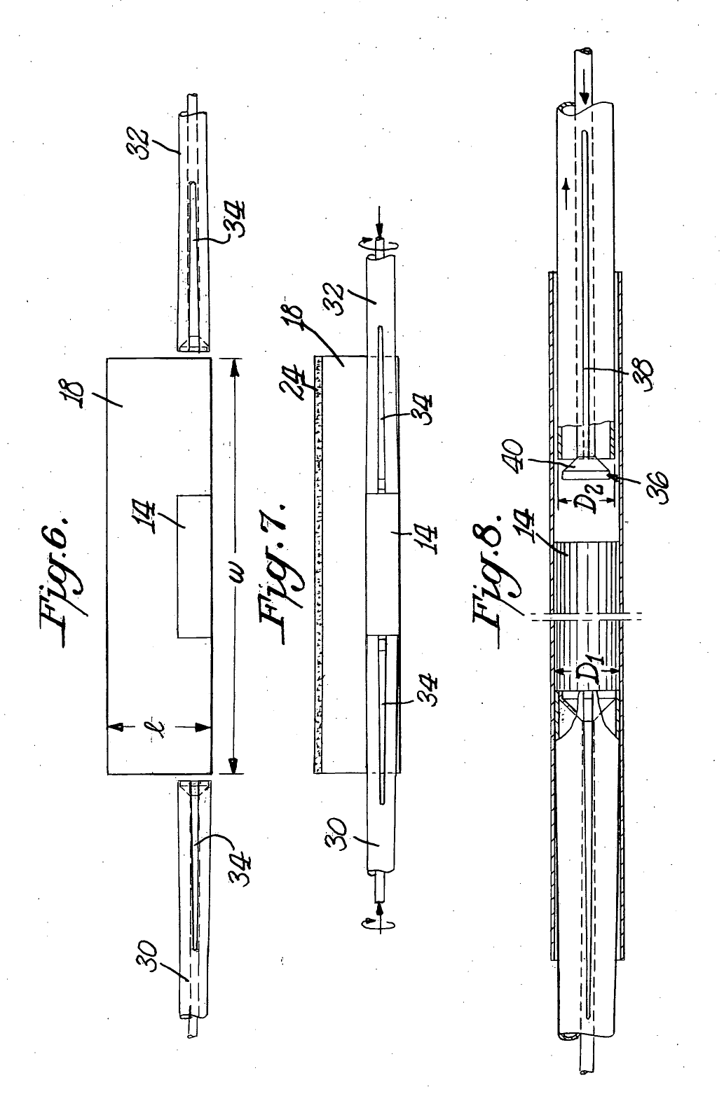

FIGS. 6-8 illustrate modified tube forming rollers 30, 32 each having a longitudinal slot 34 that allows diameter expansion and contraction of the rollers, as explained more fully below. Fundamentally, each roller has a relaxed diameter D₂ slightly smaller than the desired diameter D₁ of the formed tube. However, an internal mechanism 36 expands the diameter of each roller to the desired diameter of the formed tube prior to rolling the paper substrate 18 about the rollers. After tube formation, the internal mechanism 36 allows each roller to return to its relaxed slightly smaller overall shape which enables roller removal from the formed paper tube.

In its basic form the internal mechanism 36 associated with each roller 30, 32 includes a drawbar 38 with a tapered portion 40 at the inner end thereof. Each roller is hollow and made of resilient materials such as spring steel, for example, and each roller is constructed and arranged to receive the tapered portion 36 of the drawbar 38. As shown best in FIG. 8, the tapered portion 36 engages the open end of the roller when the drawbar is withdrawn from the roller, and continued movement of the draw bar relative to the roller causes the roller to slightly expand thereby increasing the roller diameter D₂ to the desired diameter D₁ of the tube to be formed. Thereafter the rollers 30, 32 operate in the same manner as described above in conjunction with the structure shown in FIGS. 1-4. Vacuum may be supplied to the paper substrate 18 through the longitudinal slots 34.

It should be understood that the above detailed description while indicating preferred embodiments of the invention are given by way of illustration only since various changes and modifications within the spirit and scope of the invention will become apparent to those skilled in the art from the detailed description. For example, instead of applying vacuum to the inside surface of the paper segment 18 to adhere the paper to the rollers 20, 22, physical structure on the outside of the paper segment may be used to hold it against the tube forming rollers as they rotate. Also, while the central filter segment 14 may comprise a cellulose acetate tow, a combined filter segment or a plug-space-plug filter segment may be utilized.

What is claimed is:

1. A process of producing a filter tube comprising the steps of:
providing a paper segment of given length and width;
centrally placing a filter segment on the paper segment, the filter segment having a length less than the width of the paper segment;
positioning opposed tube forming rollers against the ends of the filter segment;
adhering the paper segment to the tube forming rollers while simultaneously rotating the rollers to thereby form the paper segment into a tube shape;
securing together overlapping portions of the paper segment; and
withdrawing the rollers from within the formed filter tube.

2. A process of producing a filter tube as in claim 1 wherein the step of providing a paper segment of given length and width includes the step of removing a paper segment of given length and width from an endless paper supply, and wherein the given length is slightly longer than the diameter of the filter tube to be produced.

3. A process of producing a filter tube as in claim 2 wherein the paper segment of given length and width is removed from the endless paper supply by cutting.

4. A process of producing a filter tube as in claim 1 wherein the given length of the paper segment is slightly longer than the circumference of the filter tube to be produced.

5. A process of producing a filter tube as in claim 1 wherein the step of adhering the paper segment to the tube forming rollers includes applying vacuum from the rollers onto the paper segment.

6. A process of producing a filter tube as in claim 1 wherein the step of withdrawing the rollers from the formed filter tube includes the prestep of slightly reducing the diameter of each roller prior to withdrawal thereof from within the formed tube.

7. A process of producing a filter tube as in claim 5 wherein the step of applying vacuum from the rollers onto the paper segment includes the application of vacuum through a plurality of openings in the tube forming rollers.

8. A process of producing a filter tube as in claim 1 wherein the solid filter comprises cellulose acetate tow.

9. A process as in claim 1 wherein the step of placing a filter segment on the paper segment includes the step of selecting the filter segment from the group consisting of a solid filter segment, a combined filter segment, and a plug-space-plug filter segment.
